(19) United States
(12) Patent Application Publication
(10) Pub. No.: US 2015/0154687 A1
(43) Pub. Date: Jun. 4, 2015

(54) RESELLER SALES FORCE

(71) Applicant: Sellershood LLC, New York, NY (US)

(72) Inventors: Sebastián Matías Bellora, New York, NY (US); Guillermo Federico Bellora, New York, NY (US)

(21) Appl. No.: 14/558,138

(22) Filed: Dec. 2, 2014

Related U.S. Application Data
(60) Provisional application No. 61/911,599, filed on Dec. 4, 2013.

(51) Int. Cl. G06Q 30/06; G06Q 20/12

(52) U.S. Cl. CPC G06Q 30/0637; G06Q 20/12

(57) ABSTRACT

Embodiments of the invention generally relate to providing an online reselling platform for proactive e-commerce. In particular, merchants can publish products, together with respective prices and commissions in an online marketplace. Resellers can then browse the published products and choose one or more to sell using their own contacts and sales techniques, generating purchase orders. When a client approves and pays for a purchase order, the order is automatically passed to the merchant for fulfillment, and the payment is automatically split between the merchant, sales platform, and reseller according to specified commission rates.

### RELATED APPLICATIONS

This non-provisional patent application claims priority benefit, with regard to all common subject matter, of earlier-filed U.S. Provisional Patent Application No. 61/911,599, filed Dec. 4, 2013, and entitled “COMPUTER PROGRAM AND METHOD FOR PROVIDING A RESELLER SALES FORCE.” The identified earlier-filed provisional patent application is hereby incorporated by reference in its entirety into the present application.

### BACKGROUND

1. Field

Embodiments of the invention generally relate to providing an online reselling platform for proactive e-commerce. In particular, merchants can publish products, together with respective prices and commissions in an online marketplace. Resellers can then browse the published products and choose one or more to sell using their own contacts and sales techniques, generating purchase orders. When a client approves and pays for a purchase order, the order is automatically passed to the merchant for fulfillment, and they payment is automatically split between the merchant and reseller according to the specified commission rate.

2. Related Art

Traditional e-commerce has grown enormously since its inception, totaling over $1 trillion annually and offering a wide range of products to markets that would not support them in an offline, brick-and-mortar commerce environment. However, traditional e-commerce lacks the social aspects of offline commerce, as e-commerce is fundamentally reactive: merchants put their inventory on the web and wait for customers to come to them. The large number of merchants using online advertising to attract customers saturates the customers with advertising, rendering it ineffective as customers filter it out. Furthermore, e-commerce lacks the social interaction between customers and salespeople that can result in a better shopping experience and increased satisfaction from the purchase. Furthermore, the presence of large players in the marketplace can make it difficult for new vendors to enter the market, even if they offer superior products or prices. Finally, e-commerce is a fundamentally closed system, as each merchant must develop their own reselling channels.

### SUMMARY

Embodiments of the invention address the above problems by providing an online reselling platform for proactive e-commerce. In a first embodiment, the invention comprises a system for providing a reseller sales force, comprising a merchant portal operable to allow a merchant to manage a merchant catalog associated with the merchant and including merchandise items, view a merchant order interface including purchase orders for the merchandise items, and view invoices associated with the merchant; a reseller portal operable to allow a reseller to review a merchant catalog, generate and review purchase orders including a customer identifier and a selected merchandise item from the merchant catalog, and view one or more invoices associated with the reseller; and a customer portal operable to allow a customer to review and approve purchase orders, cause an order to be entered into a corresponding merchant's purchase order interface, provide information to make a payment for an approved purchase order, wherein one portion of the payment is credited to the merchant and another portion of the payment is credited to the reseller, and rate the reseller and the merchant.

In a second embodiment, the invention comprises a computer-implemented method for providing a reseller sales force, comprising the steps of providing a merchant user interface whereby a merchant can publish a plurality of merchandise items in an associated merchant catalog, providing a merchant order interface whereby the merchant can review approved purchase orders, providing a reseller user interface whereby a reseller can review merchant catalogs, providing a reseller order interface whereby the reseller can generate a purchase order including one of the published merchandise items and an identifier associated with a customer, providing a customer order interface whereby the customer can approve a purchase order and provide payment information, in response to the customer approving the purchase order, adding the order to the merchant order interface, and in response to receiving payment information from the customer, directing one portion of a payment made by the customer to the merchant and another portion of the payment made by the customer to the reseller.

In a third embodiment, the invention comprises a networked computer system for providing a reseller sales force comprising a data store that stores a merchant identifier, a reseller identifier, a customer identifier, a merchant catalog including the merchant identifier and a first merchandise item identifier, a first purchase order including the reseller identifier, the customer identifier and the first merchandise item identifier, and an invoice including the merchant identifier and the reseller identifier; a first plurality of computers communicatively coupled to the data store, each computer of said first plurality including computer-readable media storing a first set of computer-executable instructions which, when executed by a first processor cause the first processor to perform a method of operating a merchant portal, the method comprising the steps of providing a merchant catalog editing interface, whereby a merchant associated with the merchant identifier can add a second merchandise item to the merchant catalog, providing a merchant order interface whereby the merchant can view the first purchase order, and providing a merchant invoice interface, whereby the merchant can view the invoice; a second plurality of computers communicatively coupled to the data store, each computer of said second plurality of computers including computer-readable media storing a second set of computer-executable instructions which, when executed by a second processor cause the second processor to perform a method of operating a reseller portal, the method comprising the steps of providing a merchant catalog viewing interface, whereby a reseller associated with the reseller identifier can review the merchant catalog, providing a reseller purchase order interface whereby the reseller can generate a second purchase order including a second customer identifier and the second merchandise item and store it in the data store, and providing a reseller invoice interface, whereby the reseller can view the invoice; and a third plurality of computers communicatively coupled to the data store each computer of the third plurality of computers including computer-readable media storing a third set of computer-executable instructions which, when executed by a third processor, cause the third processor to perform a method of operating a customer portal, the method comprising the steps of providing a customer payment interface whereby a customer associated with the second customer identifier can provide payment information for the second purchase order, and providing a customer purchase order interface whereby the customer can view the second purchase order, access the payment interface, and approve the second purchase order, thereby marking the second purchase order in the merchant order interface as paid.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform that can form one element of certain embodiments of the invention;

FIG. 2 depicts a flowchart illustrating the steps in a typical sale in one embodiment of the invention;

FIG. 3 depicts an illustrative view of the merchant catalog interface in one embodiment of the invention;

FIG. 4 depicts an illustrative view of the merchant order interface in one embodiment of the invention;

FIG. 5 depicts an illustrative view of the reseller catalog interface in one embodiment of the invention;

FIG. 6 depicts an illustrative view of the reseller purchase order generation interface in one embodiment of the invention;

FIG. 7 depicts an illustrative view of the reseller order interface in one embodiment of the invention; and

FIG. 8 depicts an illustrative view of the customer order interface in one embodiment of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

Generally, embodiments of the invention relate to a system for providing merchants with a virtual sales force, which can make sales by any means, including leveraging social media, personal contacts, etc. This virtual sales force need not be formally affiliated with the merchant, other than generating orders for one or more products: there is no dependency, and no exclusivity between the merchant and the resellers. In this way, merchants increase their sales without the overhead of a dedicated sales force, resellers can earn commissions on sales by leveraging their existing social connections, and customers gain the advantage of a knowledgeable and motivated sales force. Embodiments of the invention comprise systems and methods for coordinating sales among the customers, resellers, and merchants.

It is an advantage of embodiments of the invention that the reseller acts as a sales agent rather than a traditional reseller: they enable the merchant to make sales, and earn a commission by doing so, while a traditional reseller first buys items from a merchant and then resells them. This incurs substantial risk for the reseller, including the risk that the price for the goods will fall and leave the reseller with goods that can only be sold at a loss. Another risk is that of buyers who agree to purchase an item, causing the reseller to buy it from the merchant, and then change their mind, leaving the reseller stuck with unsold goods. Other models, like accepting money from the buyer before buying the item from the merchant, may be even riskier, as in the case where the merchant runs out of stock rendering the reseller unable to fulfill the sales contract. In the present system, risks for all parties are greatly reduced, increasing the willingness of parties to participate.

For example, one embodiment of the invention includes a system for providing a reseller sales force, comprising a merchant portal operable to allow a merchant to manage a merchant catalog associated with the merchant and including merchandise items, and view a merchant order interface including purchase orders for the merchandise items; a reseller portal operable to allow a reseller to review a merchant catalog, and generate and review purchase orders including a customer identifier and a selected merchandise item from the merchant catalog; and a customer portal operable to allow a customer to review and approve purchase orders, causing an order to be entered into a corresponding merchant's purchase order interface, provide information to make a payment for an approved purchase order, and rate the reseller and the merchant.

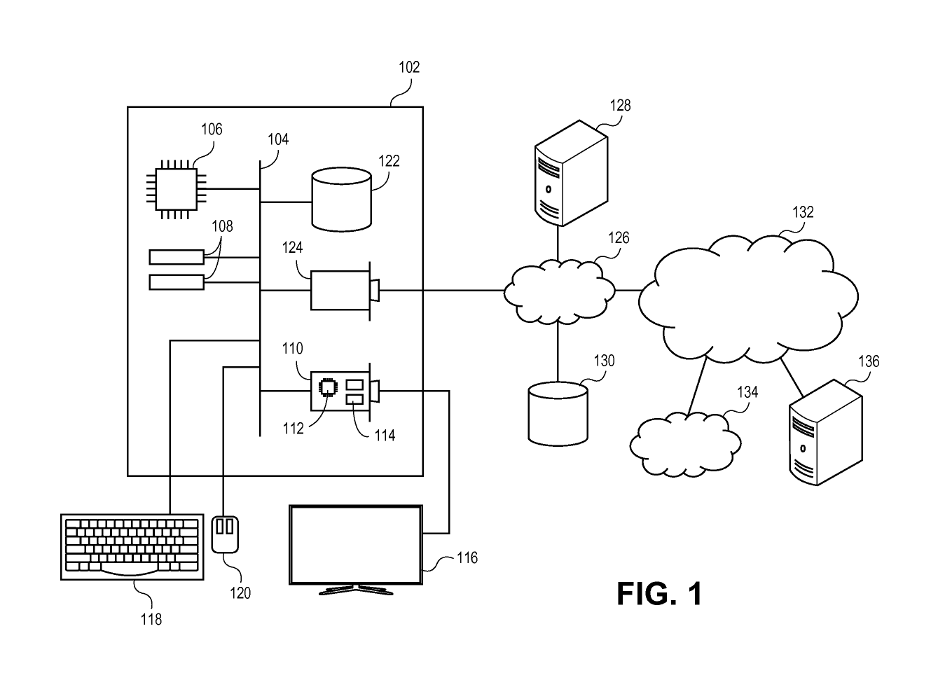

Turning first to FIG. 1, an exemplary hardware platform that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

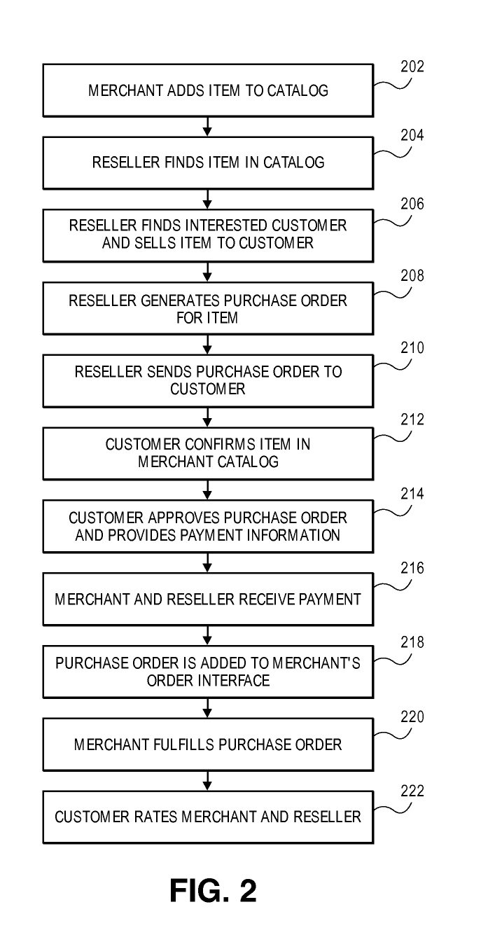

Turning now to FIG. 2, a flowchart illustrating the steps in a typical sale in one embodiment of the invention is depicted. The process begins at step 202, where the merchant publishes a product in their merchant catalog. Any product can be published, including physical goods, intangible goods, and services. Retail products as well as industrial products can be published. In some embodiments, as a part of publishing the product the merchant can specify a category for the products. In some such embodiments, the category is selected from a nested hierarchy of categories. For example, a PlayStation® 4 video game console may be categorized under the narrow category of “Home Game Consoles,” which could be a subcategory of “Video Game Consoles,” which could in turn be a subcategory of “Electronics,” and so on. In some such embodiments, the merchant can specify multiple categories for an item. In other embodiments, the merchant can specify one or more keywords for a merchandise item. For example the keywords “playstation,” “video games” “gaming” and “ps4” could be specified for the PlayStation 4 game console.

In some embodiments, the merchant may be required to furnish a description of the item as a part of the process of adding it to the catalog. This description may include general information about the product, shipping information such as available shipping methods and processing time, and return policies for the merchandise item. In some embodiments, the merchant can specify general shipping conditions and return policies that are used to prepopulate this information for each product and can then be edited to add any product-specific information. The merchant can additionally provide a picture of the merchandise item. In some embodiments, providing a picture may be required to publish the merchandise item.

In some embodiments, the merchant can additionally specify one or more variants of the product by specifying one or more attributes and their corresponding values. For example, a particular shirt could have attributes including “size” and “color.” The “size” attribute could take on values including “small,” “medium,” or “large,” while the “color” attribute could take on values including “red,” “blue,” and so forth. Each attribute can take on a different set of values, and different products may have different sets of available value for a given attribute. For example, a monitor may also include a “size” attribute, but one which takes on values including “20 inches,” “22 inches,” and “24 inches.” In some embodiments, a fixed set of attributes and values sets for the attributes are available from which the merchant can select. In other embodiments, the merchant can specify arbitrary attributes and value sets for them. In still other embodiments, attributes are suggested for the product based on those selected for other, similar products. Once the attributes and value sets have been specified, the merchant can specify the available variants of the products by selecting combinations of values for each attribute. For example, the shirt described above could have variants including “small red,” “medium red,” “large red,” “small blue,” etc. Not all combinations of attribute values are necessarily an available variant; for example, the blue shirt may not be available in large.

Once the set of available variants has been created, the merchant can specify stock, price and commission information for each variant. By specifying the quantity of each variant that the merchant has in stock, the system can prevent purchase orders from being created for sold-out items. This stock quantity can be automatically updated when the merchant fulfills an order (i.e., decremented when a reseller generates a purchase order for the item or when payment is received from a customer), or it can be manually updated if the merchant's stock changes for some other reason (for example, it can be increased appropriately if the merchant orders additional stock of an item, or decreased if the merchant sells the item outside of the system). Similarly, a price and commission can be set separately for each variant. The price for an item is the ultimate cost to the customer, while the commission is the portion of the cost that the merchant agrees to share with the reseller. Thus, merchant can compete for customers by offering the lowest price, or for resellers by offering the highest commission, or both. In some embodiments, a commission can be automatically determined based on the price and a percentage predetermined by the merchant.

After specifying price and stock, the merchant can proceed to specify shipping information for the item. In some embodiments, different shipping information can be specified for each variant of the item. In some embodiments, shipping information for an item is specified as one or more shipping methods, each with a corresponding price and availability. For example, for a particular item, “In-store pickup” could be free, while “Standard mail” could be $6.50 and “Expedited Overnight” could be $31.50 to one location, while it might not be available at all for another location. In some embodiments, the shipping rates charged to the customer for a given shipping method are automatically determined based on the customer's location and the merchant's location. In some embodiments, if the merchant has not already specified a ship-from address, they may be prompted to do so at this point. In some embodiments, the merchant can select some subset of the available shipping methods for each product or variant.

After specifying shipping information, the merchant can specify tax information for the product, or for each variant of the product. The tax information instructs the system to charge and withhold the applicable taxes for each tax jurisdiction. In some embodiments, the appropriate tax rate can be specified for each jurisdiction. In other embodiments, a default tax rate is applied to all jurisdictions and can be overridden for selected jurisdictions. In some embodiments, the merchant may additionally be required to affirm that the product is in compliance with all applicable laws and with the system terms of service. Once this process is completed, the merchandise item is added to the merchant's catalog and can be viewed by resellers.

Next, at step 204, a reseller viewing the merchant's catalog locates the merchandise item. This can happen in several ways. In those embodiments with a hierarchy of categories, a reseller can navigate through the categories and browse a listing of items in that category from all merchants. In other embodiments, resellers can search based on keywords specified for the item. In yet other embodiments, resellers can browse the catalog for a particular merchant. In still other embodiments, these methods of locating items can be combined: for example, a reseller could search for items with a particular keyword in a particular category from a particular merchant. In some embodiments, some methods of searching may intentionally be unavailable: for example, searching by merchant may be disabled to discourage a reseller mind set of being affiliated with a particular merchant and encourage the use of the product as the main focus of the relationship. In some embodiments, each merchandise item displayed includes the stock, price and commission. In this fashion, a reseller can easily locate merchandise items to resell, and for a given item compare the price and commission offered by each merchant selling the item. In some embodiments, a reseller must log into the system before being able to browse merchant catalogs. In other embodiments, a reseller can browse a partial or full view of the catalogs without being logged in.

At step 206, the reseller makes a sale of the item to the customer. In some embodiments, the system provides tools to assist the reseller in making the sale. In other embodiments, the system is completely uninvolved in making the initial sale. It is contemplated that the reseller may use any method, online or offline, to make the sale, and different resellers make use different methods. In some embodiments, the system does not know of or play any part in the methods used by resellers.

Once a customer has agreed to purchase a product, the reseller must generate a purchase order for that product, as identified at step 208. In some embodiments, a reseller must log into the system before generating a purchase order so that the commission can be properly credited. In other embodiments, the reseller need not log in, but instead includes information in the purchase order sufficient to allow the commission to be credited appropriately. In some embodiments, the interface for generating a purchase order for a merchandise item is reached from the merchant catalog entry for that item, and the reseller must accordingly re-locate the item to generate the purchase order. In some embodiments, a reseller can create a reseller catalog containing various merchandise items the reseller has selected to resell. This can assist the reseller in re-locating the item when they need to generate a purchase order. In some embodiments, the reseller can publish this catalog, either as a part of the system or independently, for potential customers to browse. In other embodiments, the catalog is for the reseller's use alone as a series of bookmarks back to merchandise items of interest.

Once the reseller has located the item the customer wishes to purchase, they can use the reseller order interface to generate a new purchase order. In some embodiments, a variant and/or quantity of the merchandise item must be selected as a part of generating the purchase order. To generate the purchase order, the reseller must supply the necessary customer information. In some embodiments, this can be as simple as supplying contact information so that the purchase order can be forwarded to the customer for approval. In some embodiments, this contact information is an email address associated with the customer for sending an email. In other embodiments, it is a cellular telephone number for sending a Short Message Service (SMS) or Multimedia Messaging Service (MMS) message. In other embodiments, information such as a ship-to address and shipping method, pickup location, authorized receiver name, or other notes may also be entered. In some embodiments, the reseller may be prompted to enter different information depending on whether the items is to be shipped to the customer or picked up in-store. In some such embodiments, the reseller is first prompted to specify whether the product is to be shipped or picked up so that the right set of fields for entering information can be provided. In some such embodiments, if a product is only available for pickup or only available to be shipped, the prompt can be skipped and the correct set of fields provided automatically. Once the reseller has entered all of the information necessary to create the purchase order, they may also be prompted to affirm their agreement to the terms of service for using the system. At this point the purchase order can be generated.

In some embodiments, once the purchase order is generated, it may be added to the reseller purchase order interface as a pending order, allowing the reseller to track the status of the order. In some embodiments, the purchase order may instead or in addition be added to the merchant's purchase order interface, allowing the merchant to reserve inventory or make other stocking decisions. In some such embodiments, the quantity in stock in the merchant's catalog may automatically be decreased by the quantity of the order. In other embodiments, stock quantity is not decreased until the customer has approved the purchase order in order to avoid false expectations and bad stock decisions.

Next, at step 210, the purchase order must be transmitted to the client. In some embodiments, once the purchase order has been generated, it is automatically transmitted to the customer for approval. In other embodiments, the reseller must provide it to the customer manually. In some embodiments, a copy of the purchase order is transmitted to the customer. In other embodiments, a link to the purchase order is provided to the customer. In still other embodiments, an identifier associated with the purchase order is transmitted to the customer, which the customer can use to locate the purchase on the customer order interface. In still other embodiments, the customer is only notified that a purchase order has been generated for them, and must visit the customer order interface to locate it. In some such embodiments, the customer can locate his purchase order by browsing the open purchase orders on the system. In other embodiments, the customer can enter their contact information as provided by the reseller during purchase order generation to pull up a list of associated purchase orders. In some embodiments, the customer is not required to login to the system or create an account to view or approve purchase orders.

When the customer accesses the purchase order generated by the reseller, at step 212, they can review the details of the order, including the information entered by the reseller, to verify their accuracy. In some embodiments, the customer is presented with merchandise information directly from the merchant's catalog to confirm that the description of the merchandise item given by the reseller is correct. In some embodiments, if the item does not match the description given by the reseller, the customer has the option to report this mismatch, thereby affecting the reseller's reputation score, as discussed in additional detail below. In some embodiments, if certain information on the purchase order is incorrect, the customer may be given the option to fix it. For example a customer may be offered the option to correct a mis-entered shipping address. In other embodiments, the customer can make more substantive changes to the order as well, such as changing the item quantity or shipping method. In some embodiments, the customer may also have to agree to a terms-of-service agreement for the service before finalizing the purchase order.

Once the customer is satisfied that the purchase order is accurate, the customer can proceed to approving the purchase order and providing payment information, at step 214. In some embodiments, a third-party payment processor is used for accepting payment information. In other embodiments, the system processes the payment information independently. Payment information generally includes all that information needed to receive payment from the customer. This information can include a credit or debit card number with billing address, Automated Clearing House (ACH) information, wire transfer information, charge account information, etc. In some embodiments, providing the payment information automatically approves the purchase order. In other embodiments, the purchase order must be approved separately from providing payment information.

In some embodiments, when the payment has been received by the system, the merchant and reseller accounts are immediately credited, as set forth in step 216. In some embodiments, a portion is additionally deducted from the payment to the merchant and/or reseller accounts as a fee for using the system. In some embodiments, this fee is based on product category. In other embodiments it is based on average sale price for the item. In still other embodiments, the fee is based on sales velocity for the product, merchant and/or reseller. In yet other embodiments, the fee is based on a combination of these and/or other factors as will be immediately apparent to one of skill in the art.

In some such embodiments, a portion of this transaction fee is credited to one or more other users of the system as a referral fee for referring the reseller or the merchant to participate in the system. This creates a viral marketing mechanism to expand the population of resellers and merchants using the system. In one embodiment, a reseller or merchant can generate a referral code that they can give to another potential merchant or reseller. If and when that prospective merchant or reseller registers with the system, they can provide the referral code as a part of the registration process, allowing the referring user to be automatically credited with the appropriate referral fees. In some such embodiments, referral fees are limited to a single level (i.e., referrers of the referrer get nothing) to avoid the usual drawbacks of pyramid or multi-level marketing schemes.

In some embodiments, this referral fee is deducted from the merchant and/or reseller portions of the payment. In some embodiments the sales tax associated with the purchase order is automatically collected in a dedicated account. In other embodiments, each merchant independently manages sales tax collection.

Payment having been collected also causes the status of the purchase order to be changed from pending to purchased in the reseller purchase order interface at step 218. In those embodiments where the purchase order has not yet been added to the merchant order interface at an earlier step in the process, is can be added at this step. In either case, it will now appear in the list of the merchant's unfulfilled orders. Similarly, if the stock quantity for the merchandise was not updated when the purchase order was generated, it can be updated now to reflect the sale. At this point the merchant can safely fulfill the order knowing that the payment has been received. It is an advantage of such embodiments that they ensure that buyers only pay if the product is available and ensure availability when the merchant tries to fulfill the order. Once the merchant has fulfilled the order, at step 220, they can update the status of the purchase order to fulfilled. In some embodiments, this has the effect only of causing the purchase order to appear in the merchant's list of fulfilled orders rather than the list of unfulfilled orders. In other embodiments, when the purchase order is marked as fulfilled, the option for the customer to rate the merchant is enabled.

At step 222, the customer rates the reseller and/or the merchant. As discussed above, the option to rate the reseller begins before purchasing the product. For example if the product is not as described by the reseller when the customer views it in the merchant's catalog in the customer purchase order interface, then the customer may give the reseller a low rating. On the other hand, if the reseller has done a good job of selling a product that meets the customer's needs, then the customer may give the reseller a high rating. Ratings may be any form of feedback. For example, a numerical score from 1 to 10 may be used, with 1 being a low rating and 10 being a high rating. As another example, a zero- to five-star system may be used with a zero-star rating being low and a five-star rating being a high rating. As a final example, a simple thumbs-up/thumbs-down rating system may be used. In other embodiments, only negative feedback is employed; i.e., if a customer is fully satisfied with the merchant and reseller, they need do nothing, while if there is a problem, they can report the problem, thereby providing negative feedback. A rating for the reseller or merchant can then be calculated based on the fraction of purchase orders with no problems reported. Similarly, once the product has been purchased and/or the order has been fulfilled, the customer can rate the merchant. For example, if the customer receives a product that does not match what was described in the merchant's catalog, the customer may give the merchant a low rating, while if the correct merchandise arrives promptly in good condition, the customer may give the merchant a high rating. Alternatively, only negative feedback may be employed, as described above. In either case, the rating may be a simple score as described above, or may additionally include a narrative description of the reason for the score.

Ratings of a reseller or merchant can then be aggregated into a reputation score associated with the reseller or the merchant. In some embodiments, a reseller's reputation score is included with all of the purchase orders that the reseller generates. For this reason, a reseller is motivated to maintain a good reputation score, as customers may be less likely to approve a purchase order from a reseller with a negative reputation. Similarly, a merchant's reputation score may appear in with items from his catalog so that a potential reseller or customer can be alerted to a merchant with a negative reputation before dealing with them. In some embodiments, reputations may have additional effects in the system. For example, search results may be sorted by the reputation of the associated merchant. In some embodiments, results from merchants with sufficiently low reputation may be excluded by default. In other embodiments resellers or merchants with sufficiently low reputations may have their accounts suspended or terminated.

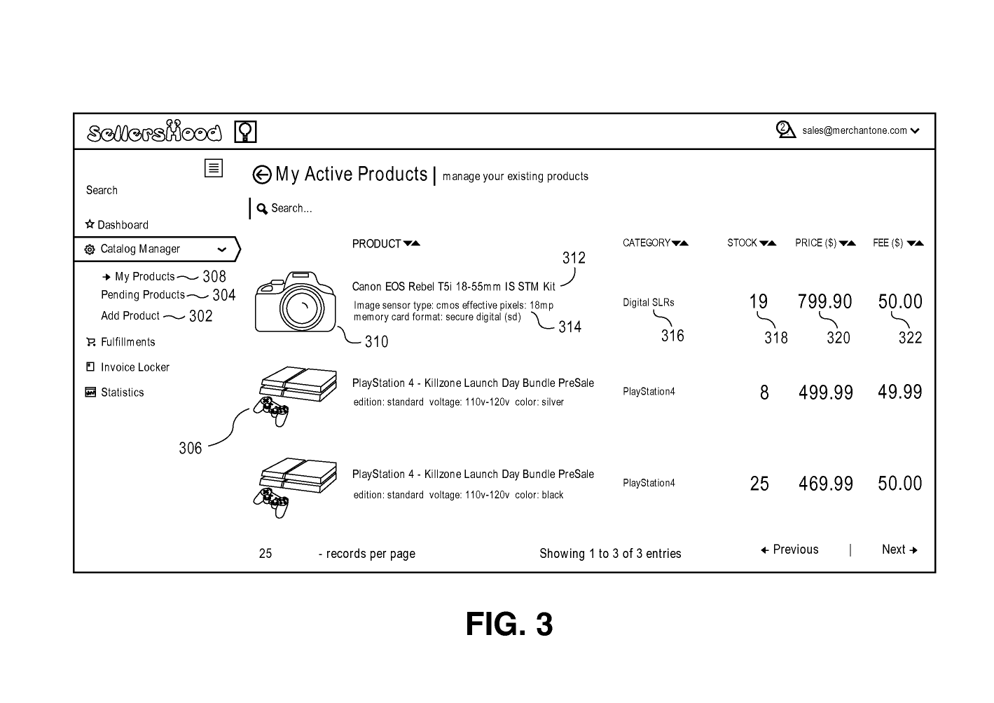

Turning now to FIG. 3, an illustrative view of the merchant catalog interface in one embodiment of the invention is depicted. As described above, the merchant catalog interface is used by the merchant to manage their catalog. From the merchant catalog interface, the merchant can add new items to the catalog using “Add Product” link 302, as described above. In some embodiments, the process of adding a product to a catalog involves multiple steps, and progress made in partially adding a product can be saved for later. In some embodiments, products can be added but not published; for example, a merchant may want to prepare a product for publication prior to its release, but not want to make it available for purchase until the product has been released. Such partially entered and unpublished products can be viewed using “Pending Products” link 304. The merchant can also return to list of active products 306 using the “My Products” link 308. In list of active products 306, a summary of the relevant information for each product is displayed. For example, thumbnail 310 of a picture of the product, name of the product 312, attribute values 314, one or more categories 316, stock 318, price 320, and commission 322. In some embodiments, the list of active products may be sortable based on some or all of these categories of information. In some embodiments, the list of active products is also searchable based on one or more keywords to allow a merchant to quickly locate a particular product.

From list of active products 306, the merchant can view additional information about individual products by selecting them from the list. In some embodiments, this view is similar to that seen by resellers when reviewing merchant catalogs and by users approving purchase orders. In some such embodiments, the merchant additionally has the ability to edit the information. For example, the merchant can change the stock quantity due to re-stocking or offline sales, edit the description of the merchandise item, or add additional keywords. In some embodiments, the merchant can edit the price and commission of a published item; however, in other embodiments, a merchant cannot alter the price or commission of a published item so that resellers do not sell an item to a customer only to find that the price has increased. In still other embodiments, the merchant can lower but not raise the price of a published item, and can raise but not lower the commission on a published item. In some embodiments, some or all of the information about a product is directly editable from the list of active products 306 without viewing the detailed information about that product.

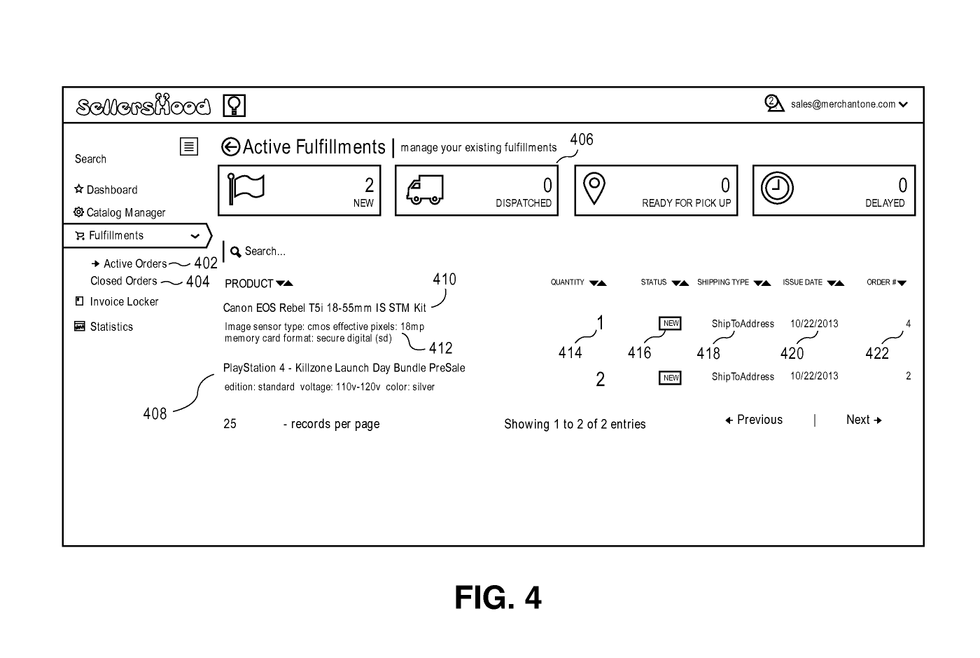

Turning now to FIG. 4, an illustrative view of the merchant order interface in one embodiment of the invention is depicted. Using this interface, a merchant can manage orders placed for the merchandise items in their catalog. In some embodiments, orders are divided into active orders (i.e., those which have not yet been fulfilled) and closed orders (i.e., those which have been fulfilled). Merchants can switch between these views using “Active Orders” link 402 and “Closed Orders” link 404. In some embodiments, a merchant can also view purchase orders for merchandise items in their catalog that have not yet been approved by the customer, and an additional link may be available to switch to a view of only those orders. In some embodiments a summary 406 of the number of purchase orders in each stage of fulfillment is also provided.

In list of orders 408, information summarizing each order is presented. For example, in the depicted embodiment, the name 410 and attribute values 412 are shown, together with the quantity 414 ordered by the customer, the status 416 of the order, the shipping type 418 of the order (i.e., whether the item is to be shipped to the customer or picked up in-store), the date 420 of the order, and an order number 422 associated with the order for tracking purposes. In some embodiments, the list of orders may be sortable based on some or all of these categories of information. From list of orders 408, the merchant can view additional details about the order by selecting it from the list. This detail view includes, for example, the destination shipping address and shipping method, or other information needed to fulfill the order. In this detail view the merchant can also update the status of an order, such as when the order has shipped. In some embodiments, the order detail view additionally includes contact information for the customer so that the merchant can communicate order updates to the customer if desired.

In some embodiments, a merchant statistics interface may also be present, presenting statistical information about the merchant's business. For example, metrics related to product, sales, and fulfillment performance can be automatically generated and displayed. Such metrics can allow the merchant to detect the best selling or most profitable products, or those that are underperforming. As another example, statistics presented in the merchant statistics interface may allow a merchant to detect that a large volume of sales are delivered to a particular state, city, or zip code. The merchant may leverage this information to put a store or distribution point near that location to improve shipping cost and delivery times. Other statistics and business analytics will be immediately apparent to one of skill in the art and are also contemplated as being within the scope of the invention.

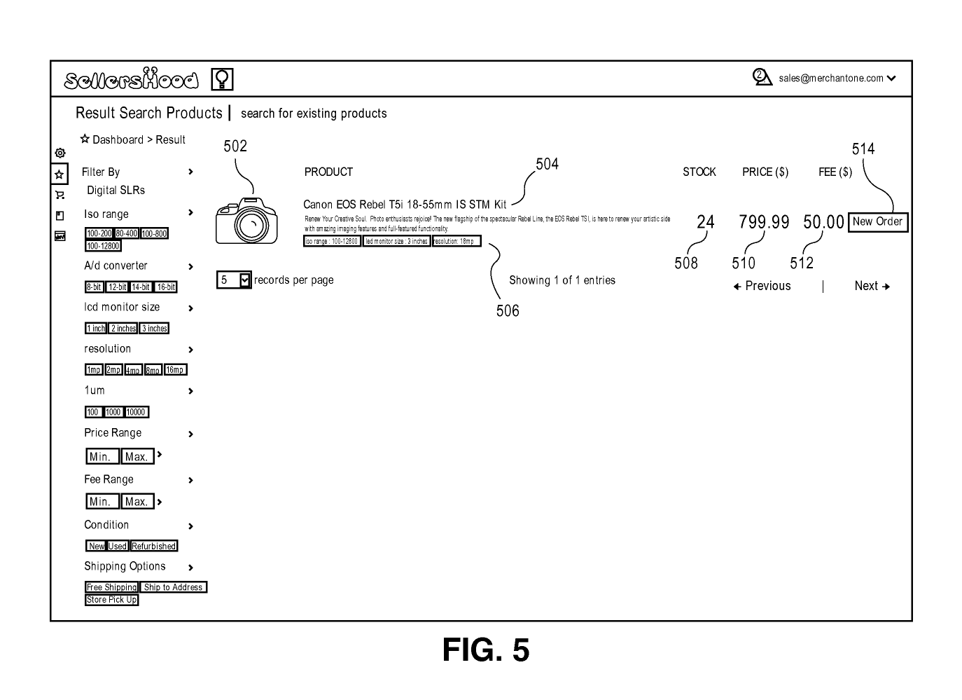

Turning now to FIG. 5, an illustrative view of the reseller catalog interface in one embodiment of the invention is depicted. As described above, a reseller can browse merchant catalogs in a number of ways: in various embodiments, resellers can perform keyword searching, browse the category hierarchy, or browse the catalog of a particular merchant. In some embodiments, these search methods can be combined by applying additional filters to a list of search result. For example, a reseller could search for the keyword “Capri,” then filter the search results by restricting to only those results in the category “Women's Clothing,” and then further filter the results by restricting to those results with a “size” attribute value of “small.” In some embodiments, an additional filter is available to restrict results based on the reputation of the associated merchant. In some embodiments, this can be a filter, enabled by default, that prevents results from merchants with reputation below a particular threshold from being included. In other embodiments, the threshold may be determined by the user, and the filter may not be enabled by default. Other filters, such as those based on shipping methods, product condition (i.e., new, used, etc.), price, commission, commission rate, may also be available in some embodiments.

As depicted, the results list includes a summary of each merchandise item matching the search criteria. In some embodiments, only a predetermined number of results are shown, with an option to view additional results. This summary is similar to that given in the merchant catalog interface, and includes thumbnail image 502, product name and description 504, attribute values 506, stock quantity 508, price 510 and commission 512. Also present in the reseller catalog interface is “New Order” button 514, which a reseller can use to access the reseller purchase order generation interface and generate a purchase order for the selected merchandise item. In some embodiments, the reseller can view the detailed product information page for the merchandise item by selecting the merchandise item from the results list. In some embodiments, the reseller purchase order generation interface is accessed instead of or in addition to the detailed product information page.

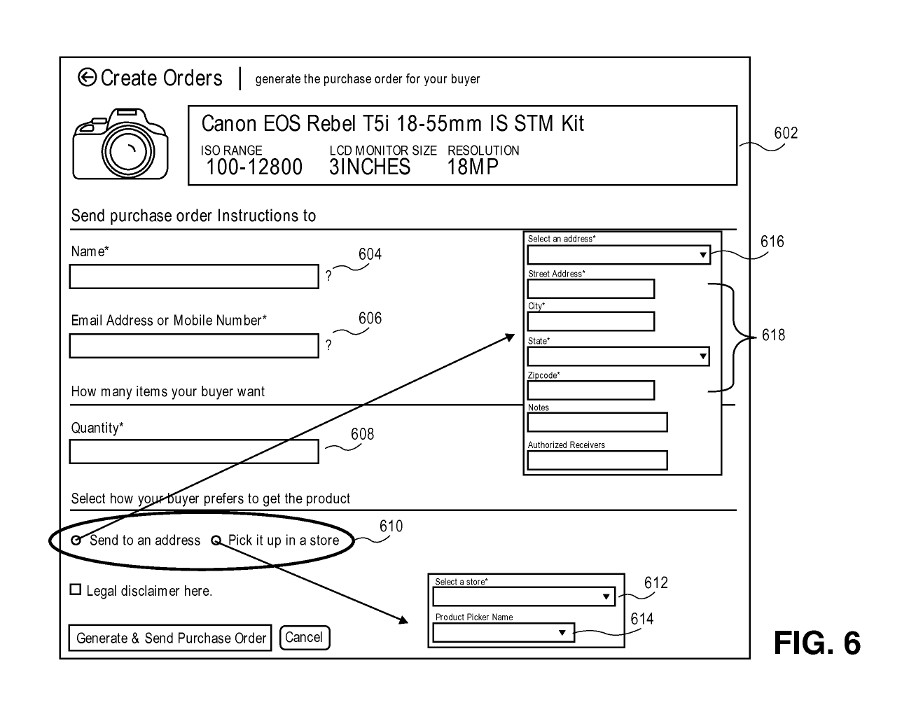

Turning now to FIG. 6, an illustrative view of the reseller purchase order generation interface in one embodiment of the invention is depicted. The reseller purchase order interface allows the reseller to input all of the information needed to create and transmit the purchase order in response to an order from a customer. The purchase order generation interface is prepopulated with the merchandise item or the variation of the merchandise item 602 that the reseller selected from the reseller catalog interface. Also present are customer name field 604 and customer contact information field 606. In some embodiments, only a single type of contact information (such as email address, cellular phone number, etc.) is able to be entered. In other embodiments, a drop-down menu or set of radio buttons is present for the reseller to specify the type of contact information entered. In still other embodiments, the type of contact information is automatically detected based on the format of the information entered. For example, if the entered information includes an ‘@’ character, the contact information may be interpreted as an email address, while if the contact information is numeric with optional punctuation, it may be interpreted as a cellular phone number. Also present is a field 608 for the reseller to specify the quantity ordered by the customer. In some embodiments, this field is prepopulated (for example, with the value “1”), and can be edited by the reseller if needed.

Also present is one or more fields for the user to enter delivery information. In some embodiments, different information may be required for in-store pickup than for shipped products. Accordingly, there may be an option 610 to select the type of delivery, which presents the correct set of fields for each type. As discussed above, certain products may only be available for in-store pickup or only available to be shipped. In these cases, the correct set of fields may automatically be selected. In simple cases, such as a product only available for in-store pickup, no additional information may be required. In other cases, store location field 612 may be provided for choosing a location where the merchant has multiple stores, or product picker field 614 may be provided for specifying an alternate person authorized to pick up the package. If delivery is instead specified, shipping method field 616 may be provided to allow the reseller to enter the customer's preferred shipping method and speed, while one or more address fields 618 can be provided for specifying a destination address. In some embodiments, additional fields may be provided for specifying delivery notes and or an authorized receiver name. Once this information has been entered, the purchase order can be generated and transmitted, as described above. In some embodiments, the reseller may be required to affirm agreement to the system terms of service prior to generating the purchase order.

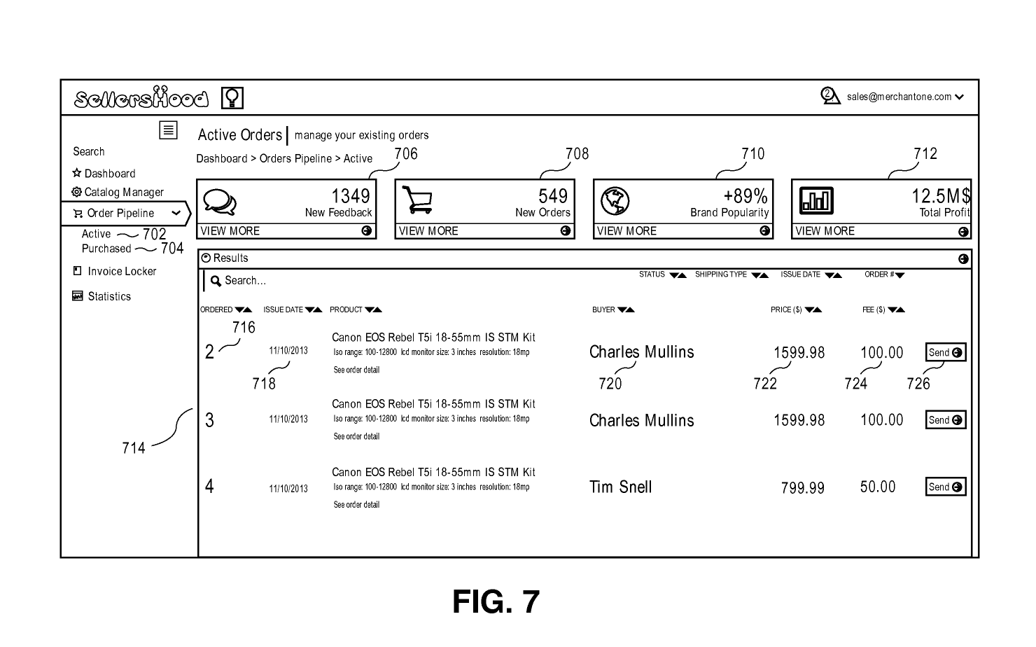

Turning now to FIG. 7, an illustrative view of the reseller order interface in one embodiment of the invention is depicted. The reseller order interface allows the reseller to view the status of the orders they have generated. In some embodiments, these orders are divided into pending orders (i.e., those which have not yet been approved by the customer) and purchased orders (i.e., those which have been approved and paid for by the client). In the depicted embodiment, these two classes of orders can be viewed using “Active Orders” button 702 and “Purchased Orders” button 704. In some embodiments, a series of summary graphics illustrating aspects of the resellers business are also displayed. In the depicted embodiment, included are feedback graphic 706, new order graphic 708, brand popularity graphic 710, and profit graphic 712.

Order list 714 is similar to the order list in the merchant order interface, but provides information about each order that is relevant to the reseller. Included in the displayed embodiment is the order identifier 716, which is shared between the order in the reseller order interface and the corresponding order in the merchant order interface so that merchant and resellers can easily locate a common order. Also included is issue date 718, indicating the date the purchase order was sent to the customer for approval and a summary of the merchandise item purchased, similar to that shown in the merchant order interface. Unlike the depicted merchant order interface, the depicted reseller order interface prominently features the customer name 720 so that the merchant can easily leverage the social connection that enabled the reseller to make the sale in the first place. Also included are price 722 and commission 724. Finally, the depicted embodiment includes a “resend” button for each order allowing the reseller to resend the purchase order to the customer in the event the customer loses or fails to receive the initial order. As was the case in the merchant order interface, the reseller can select any order on the order list for a detailed view of the order.

In some embodiments, a reseller statistics interface may also be present, similar to the merchant statistics interface, but presenting statistical information about the reseller's business. In this case, metrics related to products, sales, and customers can be automatically generated and displayed. Such metrics can allow the reseller to manage customer relationships and determine which products sell best among particular customer groups and can aid in deciding when, what, and to whom to sell a product. For example, one customer may buy electronics but not clothes; thus, future sales to that customer can be focused appropriately. As another example, another customer may always buy something for Mother's Day, suggesting that the weeks immediately prior may be a good time to approach that customer. Alternatively, a third customer who has never bought anything despite expressing interest and being sent multiple purchase could be de-emphasized in future sales efforts. Statistics generated can include metrics like sales effort per actual sales for each customer or sales effort per profit amount. Other metrics will be immediately apparent to one of skill in the art, and are contemplated as within the scope of the invention.

In some embodiments, customer-relationship management (CRM) features for the reseller may also be included in addition or as a part of the reseller statistics interface. Resellers can have a customer contact list associated with the previous purchase orders generated or completed and integrated with statistical information about purchase ratio, dates, etc. In some embodiments, sales campaign information can also be included. Customer contact information can be added manually any time, imported from another source (for example, one or more of the reseller's social networks, or contact management software), or can be automatically taken from purchase orders as they are generated. Once the contact information has been entered or imported once, the reseller can select it instead of needing to type every time when additional sales are made to the same customer. If one or more elements of the contact information changes, the reseller can edit the information in the purchase order as it is generated and the contact information can be automatically updated.

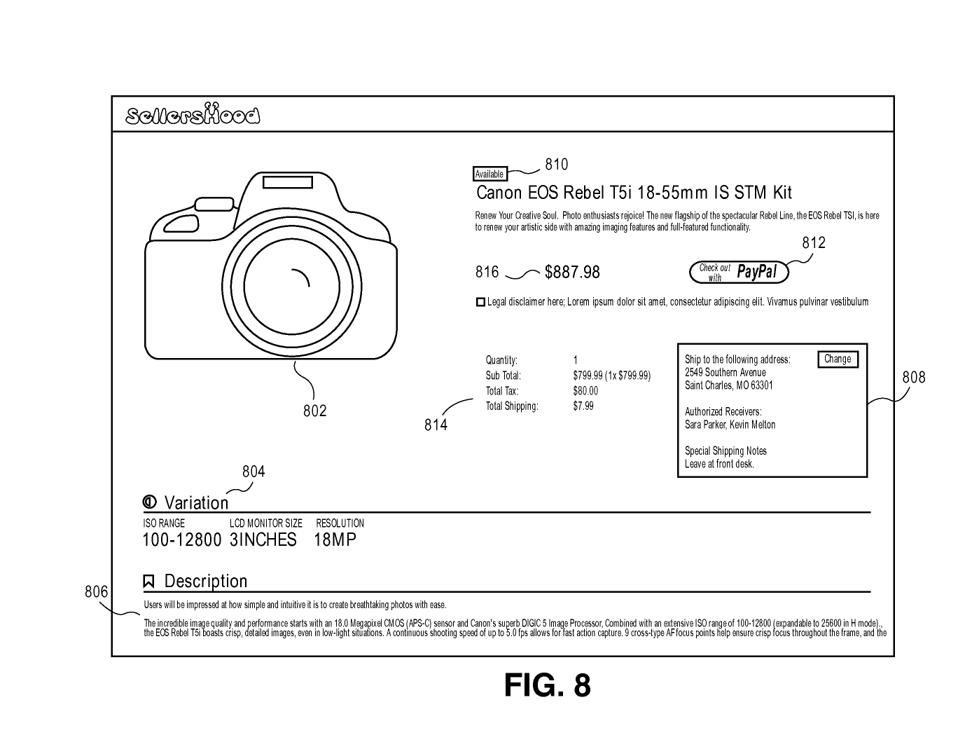

Turning now to FIG. 8, an illustrative view of the customer order interface in one embodiment of the invention is depicted. In some embodiments, the purchase order sent to the customer includes a link directly to the customer order interface. In other embodiments, the customer is provided with a purchase order number or code and, in some such embodiments, with a PIN as well. The customer can then visit the system and enter the purchase order number or code, together with the PIN (if it was provided), to access the customer order interface. Included in the customer order interface are the image 802, variant information 804, and object description 806 taken directly from the merchant's catalog for the item in question. In this way, the customer can see precisely what the merchant is offering, regardless of what the reseller indicated. In some embodiments, an option to report a mismatch between what the reseller claimed the product to be and what the item appears to be in the merchant's catalog is included in the customer order interface. Such reports can impact the reseller's reputation score, as described above.

Also included in the customer order interface is the shipping information 808 as entered by the reseller. In some embodiments, this information can be edited by the customer in case of error by the reseller or a change of address for the customer. In some embodiments, such as where merchant stock is not reserved when a purchase order is generated, a status indicator 810 is also included in the customer order interface indicating whether the merchant has any stock available. If the merchant is out-of-stock, then customer may be offered the option to back order the merchandise item. In other embodiments, “Check Out” button 812 may be instead or in addition replaced by an “Out Of Stock” indicator if the merchant stock quantity for the item is zero. Also displayed in customer order interface is price breakdown 814 and total price 816. Once the customer verifies all of the information associated with the order, they can proceed to the customer payment interface to pay for the order. In some embodiments, the customer may also be required to affirm acceptance of the system terms of use before proceeding.

One of ordinary skill in the art will appreciate that payment information can be received in a variety of ways, either directly by the system or via a third-party payment processor. As described elsewhere, payment information generally includes all information necessary to collect payment from the customer. Once the customer provides payment information via the customer payment interface, the order is approved and processing proceeds to fulfillment by the merchant as described elsewhere. At this point, customer order interface can be update to show that payment for the order has been received and additional order status information, such as tracking information can be displayed.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for providing a reseller sales force, comprising:
a merchant portal operable to allow a merchant to:
manage a merchant catalog associated with the merchant and including one or more merchandise items; and
view a merchant order interface including one or more purchase orders for the one or more merchandise items;
a reseller portal operable to allow a reseller to:
review a plurality of merchant catalogs; and
generate and review purchase orders including a customer identifier and a selected merchandise item from a merchant catalog of the plurality of merchant catalogs;
a customer portal operable to allow a customer to:
review and approve purchase orders, thereby causing an order to be entered into a corresponding merchant's order interface;
provide information to make a payment for an approved purchase order, wherein a first portion of the payment is credited to the merchant and a second portion of the payment is credited to the reseller; and
rate the reseller and the merchant.

2. The system of claim 1, wherein a quantity associated with the selected merchandise item in the merchant catalog is decremented when payment is credited to the merchant.

3. The system of claim 1, wherein each of the one or more merchandise items can include an attribute.

4. The system of claim 3, wherein the attribute is defined by the merchant when the one or more merchandise items are added to the merchant catalog.

5. The system of claim 1, wherein the merchant catalog includes a price and a commission associated with each merchandise item and wherein the commission corresponds to the second portion of the payment made by the customer.

6. The system of claim 5, wherein the merchant specifies the price and the commission associated with a new merchandise item at the time the new merchandise item is added to the merchant catalog.

7. The system of claim 1, wherein a third portion of the payment is retained as a transaction fee for using the system.

8. The system of claim 1, wherein the reseller can search one or more merchant catalogs by keyword and generate a new purchase order including one or more resulting merchandise items.

9. The system of claim 1, wherein generating a purchase order includes transmitting the purchase order to an associated customer for approval.

10. A computer-implemented method for providing a reseller sales force, comprising the steps of:
providing a merchant user interface whereby a merchant can publish a plurality of merchandise items in an associated merchant catalog;
providing a merchant order interface whereby the merchant can review approved purchase orders;
providing a reseller user interface whereby a reseller can review one or more merchant catalogs;
providing a reseller order interface whereby the reseller can generate a purchase order including one of the published merchandise items and an identifier associated with a customer;
providing a customer order interface whereby the customer can approve purchase order and provide payment information;
in response to the customer approving a purchase order, adding the order to the merchant order interface; and
in response to receiving payment information from the customer, directing a first portion of a payment made by the customer to the merchant and a second portion of the payment made by the customer to the reseller.

11. The method of claim 10, wherein the merchant specifies the first portion of the payment and the second portion of the payment when adding the one of the published merchandise items to the associated merchant catalog.

12. The method of claim 10, further comprising the step of transmitting the purchase order to the customer for approval.

13. The method of claim 10, further comprising the step of providing a customer rating interface whereby the customer can rate the merchant and the reseller.

14. The method of claim 10, wherein the step of providing the customer order interface includes the sub-step of presenting, to the customer, a portion of the merchant catalog including the one of the published merchandise items.

15. A networked computer system for providing a reseller sales force comprising:
a data store, storing:
a merchant identifier;
a reseller identifier;
a customer identifier;
a merchant catalog including the merchant identifier and a first merchandise item identifier;
a first purchase order including the reseller identifier, the customer identifier and the first merchandise item identifier; and
a first plurality of computers communicatively coupled to the data store, each computer of said first plurality including computer-readable media storing a first set of computer-executable instructions which, when executed by a first processor cause the first processor to perform a method of operating a merchant portal, the method comprising the steps of:
providing a merchant catalog interface, whereby a merchant associated with the merchant identifier can add a second merchandise item to the merchant catalog;
providing a merchant order interface whereby the merchant can view the first purchase order;
a second plurality of computers communicatively coupled to the data store, each computer of said second plurality of computers including computer-readable media storing a second set of computer-executable instructions which, when executed by a second processor cause the second processor to perform a method of operating a reseller portal, the method comprising the steps of:
providing a merchant catalog interface, whereby a reseller associated with the reseller identifier can review the merchant catalog;
providing a reseller purchase order interface whereby the reseller can generate a second purchase order including a second customer identifier and the second merchandise item and store it in the data store; and
a third plurality of computers communicatively coupled to the data store, each computer of the third plurality of computers including computer-readable media storing a third set of computer-executable instructions which, when executed by a third processor, cause the third processor to perform a method of operating a customer portal, the method comprising the steps of:
providing a customer payment interface whereby a customer associated with the second customer identifier can provide payment information for the second purchase order;
providing a customer purchase order interface whereby the customer can view the second purchase order, access the payment interface, and approve the second purchase order, thereby marking the second purchase order in the merchant order interface as active.

16. The computer system of claim 15, wherein the method of operating a customer portal further comprises the step of providing a customer rating interface whereby the customer can rate the merchant and the reseller.

17. The computer system of claim 15, wherein the method of operating a merchant portal further comprises the step of allowing the merchant to specify a price and a commission for the second merchandise item.

18. The computer system of claim 15, wherein the method of operating a customer portal further comprises the step of directing a first portion of a payment corresponding to payment information provided by the customer to the merchant and a second portion to the reseller.

19. The computer system of claim 15, wherein the method of operating the reseller portal further comprises the step of transmitting the second purchase order to the customer for approval.

20. The computer system of claim 15, wherein the step of providing the customer order interface includes the sub-step of presenting, to the customer, a portion of the merchant catalog including the second merchandise item prior to the customer approving the second purchase order.
